(19) United States
(12) Patent Application Publication
(10) Pub. No.: US 2020/0284068 A1
(43) Pub. Date: Sep. 10, 2020

(54) LATCH WITH INTEGRATED DOOR PRESENTER AND REMOTE ACTUATOR

(71) Applicant: MAGNA CLOSURES INC., NEWMARKET (CA)

(72) Inventors: Francesco CUMBO, Pisa (IT); Francesco PATANE, Newmarket (CA)

(21) Appl. No.: 16/811,736

(22) Filed: Mar. 6, 2020

Related U.S. Application Data
(60) Provisional application No. 62/815,597, filed on Mar. 8, 2019.

(51) Int. Cl. E05B 81/04; E05B 79/20

(52) U.S. Cl. CPC E05B 81/04; E05Y 2900/531; E05B 79/20

(57) ABSTRACT

An actuation system for a closure panel of a vehicle, the actuation system having: a base portion for mounting to a body of the vehicle, the base portion having mounted thereon on a latch mechanism for latching the closure panel between a locked and an unlocked state and a presenter mechanism for presenting the closure panel with respect to the body between a home position and a presentment position; and a remote actuator positioned on the body of the vehicle remote from the base portion, such that a presenter linkage operatively couples operation of the remote actuator to the presenter mechanism, in order to move a presentment member of the presenter mechanism from the home position to the presentment position.

### CROSS-REFERENCE TO RELATED APPLICATION

This application claims priority from the benefit of the filing date of U.S. Provisional Patent Application No. 62/815,597 filed on Mar. 8, 2019, entitled “LATCH WITH INTEGRATED DOOR PRESENTER AND REMOTE ACTUATOR”, the contents of which are herein incorporated by reference.

### TECHNICAL FIELD

The present invention relates in general to actuation of vehicle door components.

### BACKGROUND

Current closure panel latch systems and presenter systems can require respective actuators that are integrated into the latch and the presenter. This solution is problematic in most applications, since integrated actuators increase the system packaging in the glass area of the vehicle door and can therefore hinder the design of thinner doors. The integrated actuator format can also cause undesirable constraints to the positioning of the latch and presenter systems, especially due to current complex glass shapes and associated impact safety systems also present in the door. Another disadvantage of integrated actuators is that the latch and/or presenter can be exposed to environmental elements (e.g. water and dirt) and thus the integrated actuator and associated kinematics should also be similarly well protected from the environmental factors.

Another disadvantage to integrated actuators is that the door presentment function is quite often available on higher end vehicles, which also include cinching functionality. In this case, multiple actuators are necessary in order to provide for both presentment functionality and cinching functionality.

### SUMMARY OF THE INVENTION

It is an object of the present invention to provide an actuation system to obviate or mitigate at least one of the above presented disadvantages.

A first aspect provided is an actuation system for a closure panel of a vehicle, the actuation system having: a base portion for mounting to a body of the vehicle, the base portion having mounted thereon on a latch mechanism for latching the closure panel between a locked and an unlocked state and a presenter mechanism for presenting the closure panel with respect to the body between a home position and a presentment position; and a remote actuator positioned on the body of the vehicle remote from the base portion, such that a presenter linkage operatively couples operation of the remote actuator to the presenter mechanism, in order to move a presentment member of the presenter mechanism to affect positioning of the closure panel between the home position and the presentment position

A second aspect provided is an actuation method for operating a closure panel of a vehicle, the method comprising the steps of: receiving a presentment instruction for operating a presenter mechanism from a home position to a presentment position, the presenter mechanism having a plunger for moving the closure panel from the home position to the presentment position, the presenter mechanism integrated on a base portion with a latch mechanism for latching and unlatching the closure panel with respect to a body of the vehicle; and operating a remote actuator positioned on the body remote from the base portion in order to manipulate a presenter linkage operatively coupling the remote actuator to the plunger, in order to move the plunger from the home position to the presentment position.

### BRIEF DESCRIPTION OF THE DRAWINGS

The non-limiting embodiments may be more fully appreciated by reference to the following detailed description of the non-limiting embodiments when taken in conjunction with the accompanying drawings, by example only, in which:

FIG. 1 shows a perspective view of a vehicle having integrated latch and presenter assemblies;

FIG. 2a is an example embodiment of the presenter mechanism in a home position for the vehicle of FIG. 1;

FIG. 2b is an example embodiment of the presenter mechanism in a presentment position for the vehicle of FIG. 1;

FIG. 3 is a perspective view of an integrated presenter and latch assemblies connected to a remote actuator for the vehicle of FIG. 1;

FIGS. 4 and 5 shown an example latch of the vehicle of FIG. 1;

FIG. 6 shows a plan view of the embodiment of FIG. 3;

FIG. 7 shows a plan view of a further embodiment of the integrated latch and presenter assemblies of FIG. 1;

FIG. 8 shows a perspective view of the further embodiment of FIG. 7;

FIGS. 9 and 9A show example component views of a control system for the embodiment of FIGS. 7 and 8;

FIGS. 10 and 10A show example component views of a control system for the embodiment of FIG. 3;

FIG. 11 shows an example operation of the control system of FIGS. 9 and 10; and

FIG. 12 shows a latch controller configured with steps for controlling the remote actuator, in accordance with an illustrative example configuration.

### DETAILED DESCRIPTION

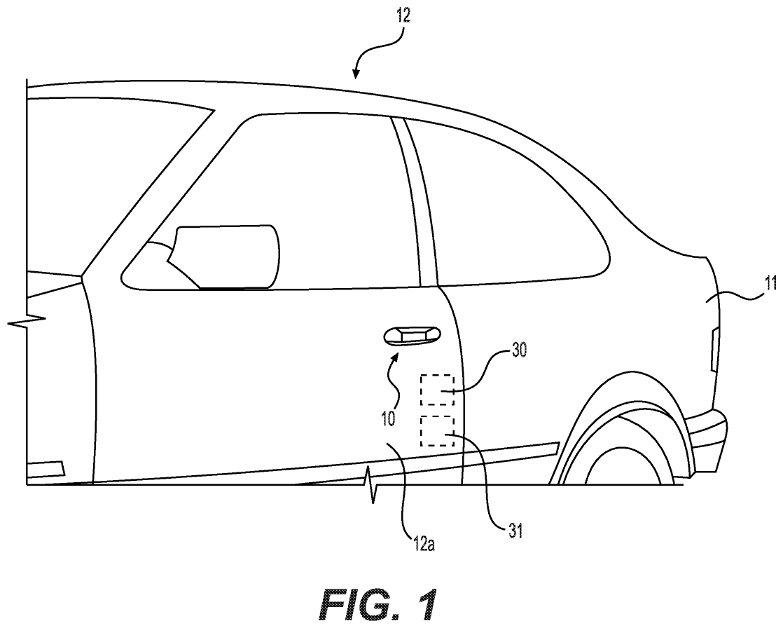

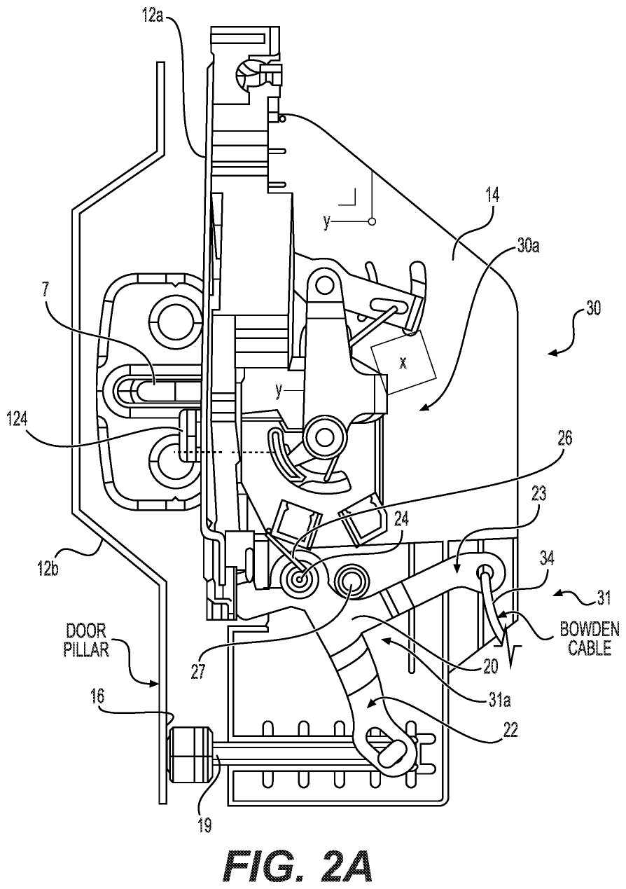

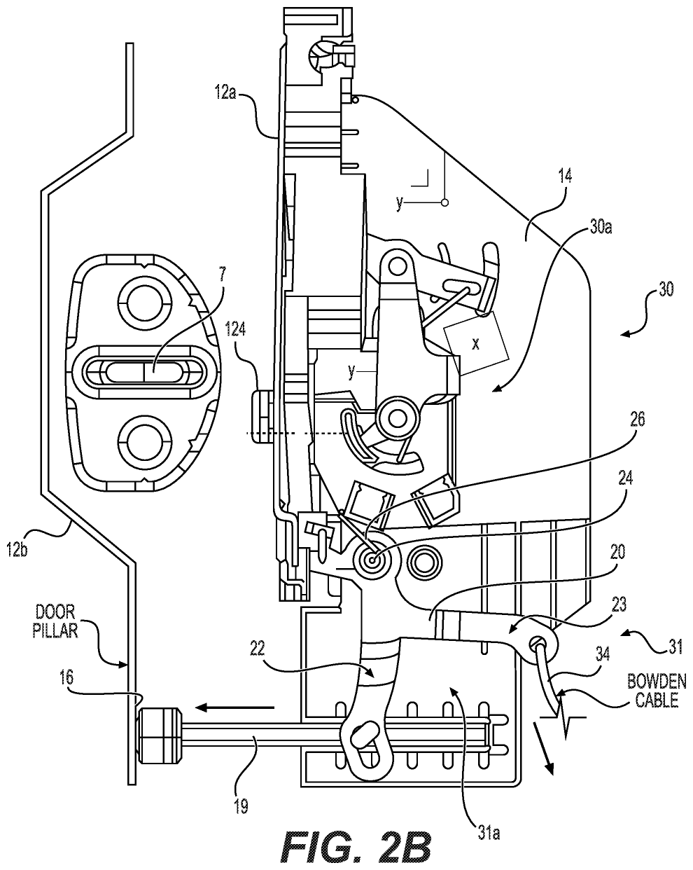

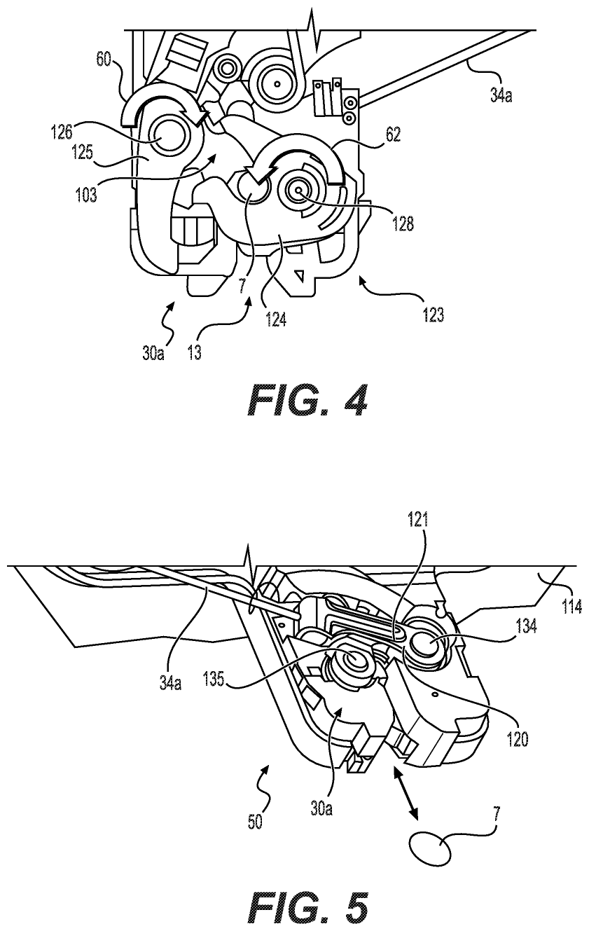

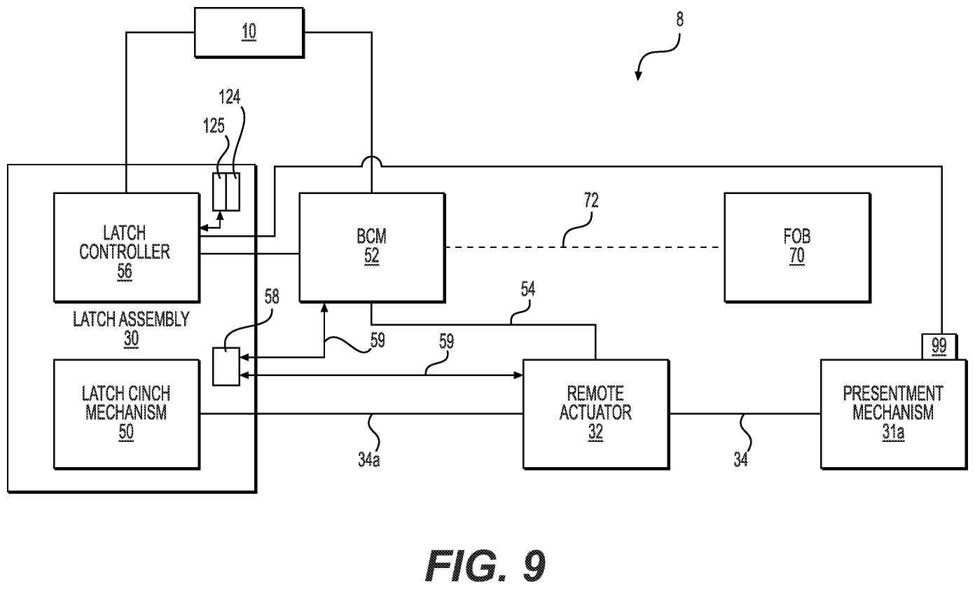

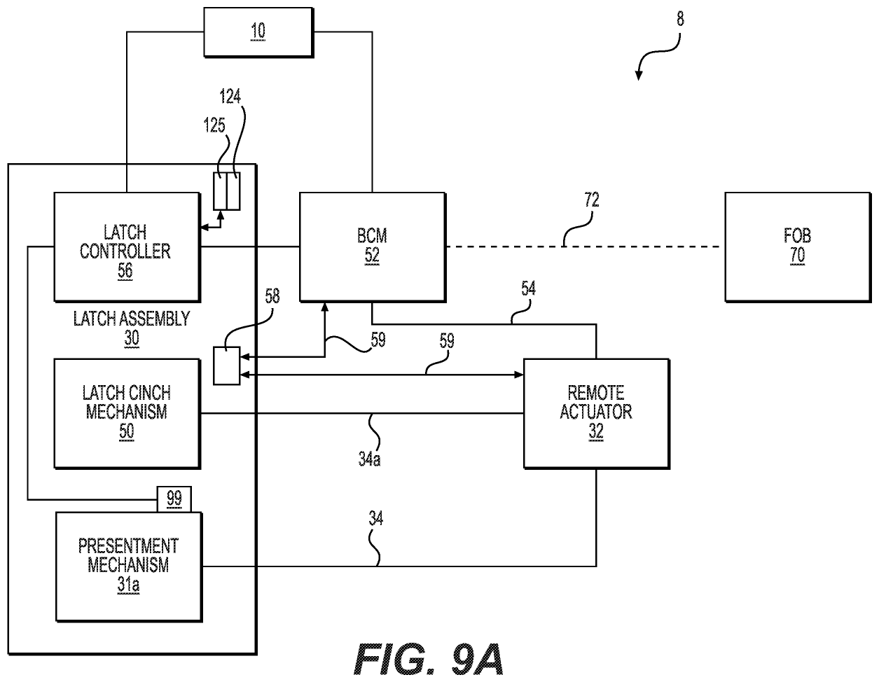

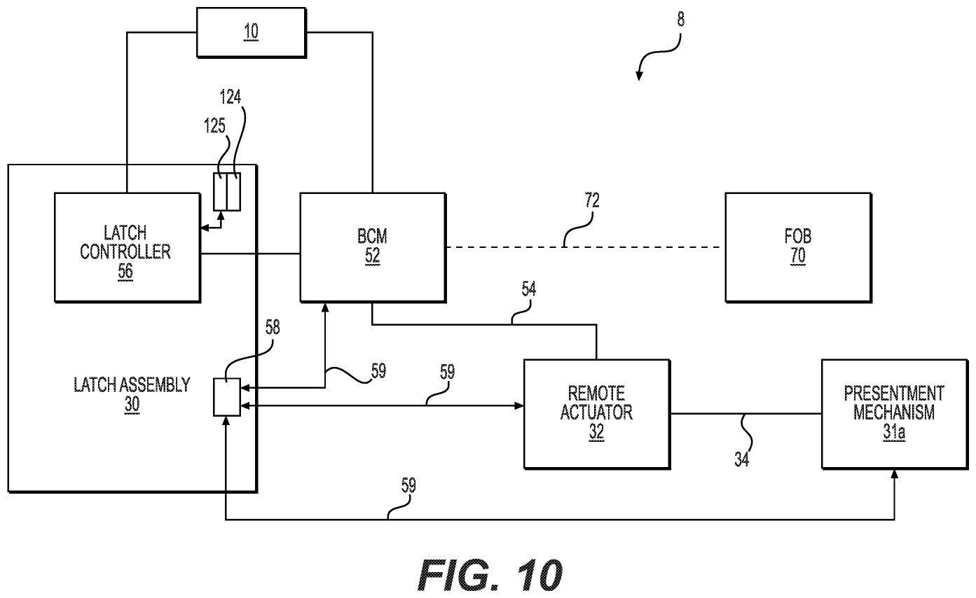

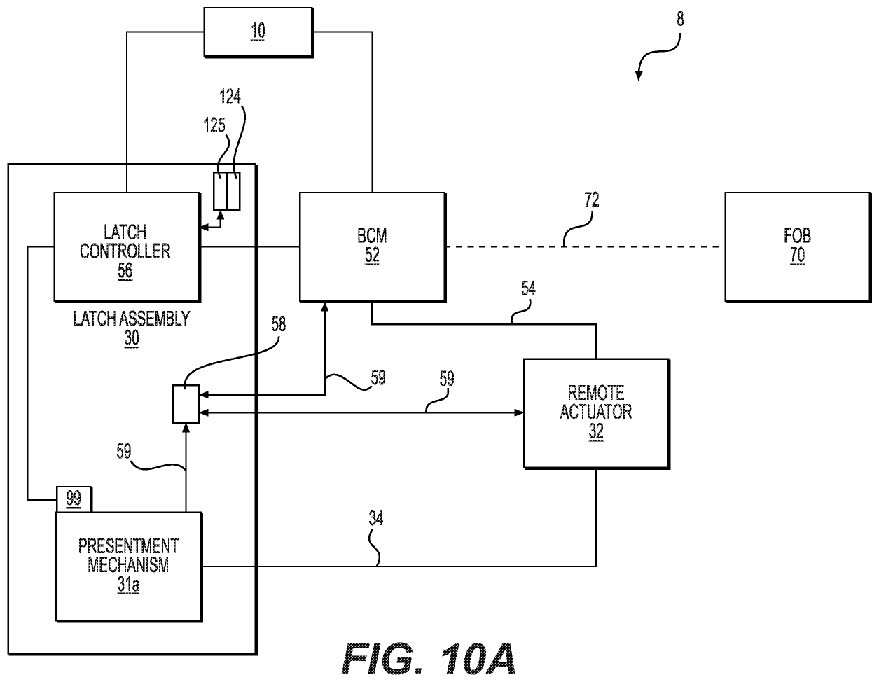

Referring now to the drawings and the illustrative embodiments depicted therein, a door presenter assembly 31 integrated with a latch assembly 30 is mountable to a door 12a (e.g. a closure panel 12a) of a vehicle 12. The latch assembly 30 and the door presenter assembly 31 are operable by a handle 10 (or other control mechanism such as but not limited to a wireless FOB or other vehicle controller—see FOB 70 and latch controller 56 in FIGS. 9 and 10 by example), in order to release a latch mechanism 30a (see FIG. 4) and to operate a presenter mechanism 31a in order to open the door 12a (see FIGS. 1 and 2a). It is recognized that the latch mechanism 30a can be part of the latch assembly 30 and the presenter mechanism 31a can be part of the presenter assembly 31. The vehicle 12 has a body 11, which can also be referred to as a frame (e.g. of the general vehicle 12 and/or of the individual doors 12a as desired). The body 11 can include a door pillar 12b, as further described below. It is also recognized that the door 12a can be referred to as a closure panel 12b, as desired.

Referring to FIG. 2a, the door presenter assembly 31 and latch assembly 30 are mounted on a base portion 14 (or bracket 14) that is mountable to the door 12a (or otherwise integrated into a door assembly—such as but not limited to a door frame with interior and exterior panels) The door 12a is positioned adjacent to the door pillar 12b, for example also having a striker 7 mounted thereon, as well as a presenter abutment surface 16 for interacting with a plunger 19 (e.g. also referred to as a presentment member 19) of the presenter mechanism 31a. As such, the presentment member 19 is extended towards the door 12b when operated on by the presentment lever 20, such that extension of the presentment member 19 causes the door 12b to be moved between the home position and the presentment position.

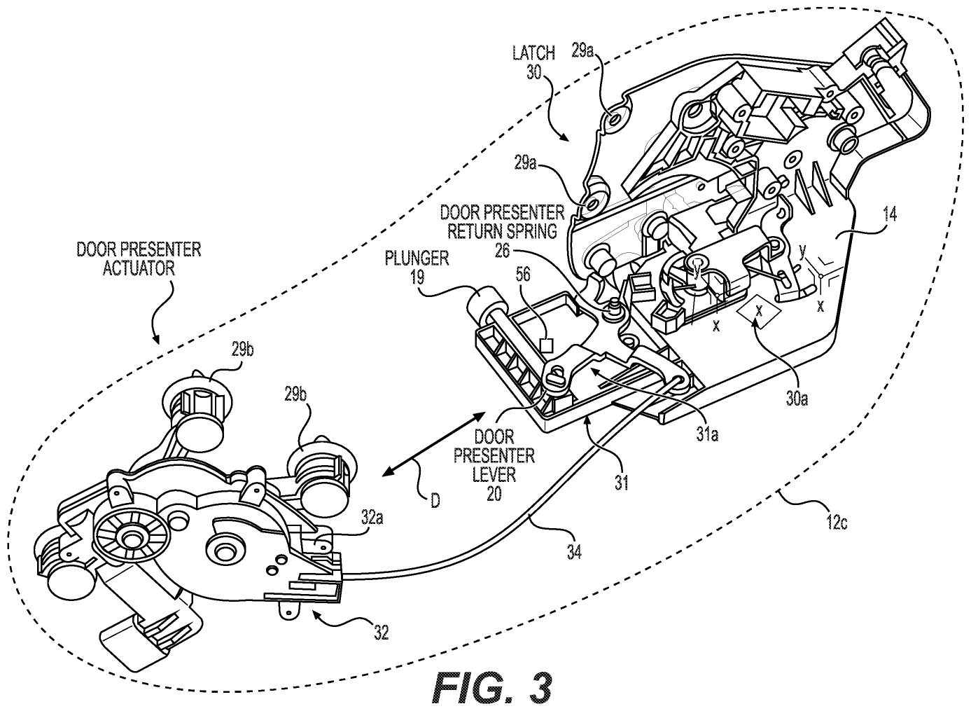

The presenter mechanism 31a also has a presentment lever 20 pivotally connected to the base portion 14 at pivot 24. The presentment lever 20 has a first portion 22 (e.g. arm) connected to the plunger 19 and a second portion 23 (e.g. arm) connected to a presenter linkage 34 (e.g. cable or rod or the like, such as a Bowden cable) of a remote actuator 32 (see FIG. 3). A resilient element 26 (e.g. coil spring) can be connected to the base portion 14 and to the presentment lever 20 (e.g. about the pivot 24), in order to bias the presentment lever 20 into a home position (as shown in FIG. 2a). The home position can be referred to as the rotational (e.g. angular) position of the presentment lever 20 about the pivot 24, when the door 12a is closed (e.g. the latch mechanism 30a is in a primary or secondary latched state).

A stop 27 can be mounted to the base portion 14, in order to position the presentment lever 20 in the home position when driven (e.g. biased) by the resilient element 26 about the pivot 24. In FIG. 2a, the latch mechanism 30a is shown in the latched state, such that a ratchet 124 of the latch assembly 30a is engaged with the striker 7. Accordingly, when the ratchet 124 is engaged with the striker 7, the door 12a can be considered in the latched or locked state (also referred to as position as desired).

Referring to FIG. 2b, shown is the latch mechanism 30a in the unlatched state (e.g. the ratchet 124 is disengaged with the striker 7) and the presenter mechanism 31a is in the presentment position, i.e. the plunger 19 is operated by the presentment lever 20 in order to push against the presenter abutment surface 16 and thus move/position the door 12a away from the door pillar 12a. As such, the presenter linkage 34 is used to actuate (e.g. pull) the second portion 23 of the presentment lever 20 against the bias of the resilient element 26, thus moving the plunger 19 from the home (or rest) position shown in FIG. 2a to the presentment position shown in FIG. 2b. A sensor 99 (see FIG. 9), such as a hall sensor electrically coupled to a latch controller 56 can be provided to detect the position of the plunger 19, for example by sensing a magnet fixed to the plunger 19. Other detectors, such as a switch can also be provided for detecting the position of the plunger 19 and providing position information to the latch controller 56. Other types of sensors or switches can also similarly be associated with the ratchet 124 and pawl 125, such that the position(s) of the ratchet 124 and/or the pawl 125 (see FIG. 4) can be reported to the latch controller 56. In this regard, the position of the plunger 19 can be sensed explicitly and/or can be determined (e.g. sensed implicitly) based on sensed measurement(s) for other components (e.g. the pawl 125, the ratchet 124, etc.) of the presenter mechanism 31a and/or the latch mechanism 30a, as desired.

Referring to FIG. 3, shown is an example assembly of the remote actuator 32 and the door presenter assembly 31 with latch assembly 30 integrated or otherwise mounted on the base portion 14, such that mountings 29a,b are used to mount the base portion 14 (now containing the latch assembly 30 and presenter assembly 31 mounted thereon) and the remote actuator 32 to the door 12a (shown in ghosted view). It is recognized that the base potion 14 is separate from a housing 32a of the remote actuator 32, such that a distance D separates the housing 32a from the base portion 14, when they are respectively mounted via their respective separate mountings 29b and 29a on the door 12a. Housing 32a may in one possible configuration enclosing one or more cable drums around which cables 34, 34a can be wound or unwounded for actuating cables 34, 34a. For example, a motor housed within housing 32a may be configured to rotate the one or more of the cable drums independently or dependently for actuating cables 34, 34a. As such, the presenter linkage 34 is used to bridge the distance D and thus operatively couple the remote actuator 32 with the presenter mechanism 31a of the presenter assembly 31. For example the remote actuator 32 is separate or distinct from the door presenter assembly 31 and/or latch assembly 30, and in other words may not be configured to have a shared base or shared supporting structure connectable as a singular unit to the body 11, but rather each have distinct bases or shared frames each mounted to the body 11 as separate units, for example mountable separately using each dedicated fasteners such as to the sheet metal or door module/carrier of the closure panel 12a for example. For these reasons, the body 11 may not be considered as a common base or shared frame for the remote actuator 32 since it is a separate unit that is the body 11 is a component in addition to the separate housings/mountings of the latch assembly 30 and the door presenter assembly 31.

As such, the handle 10 (or other door 12a opening device such as a FOB 70, proximity sensor 99, etc.) can be used by the user (e.g. such as via pulling/operating by the user) to actuate the presentment lever 20 (having one or more members or arms) connected to the base portion 14 by moving the presenter linkage 34 (e.g. cable or rod or the like) connected to plunger 19. The movement of the presentment lever 20 provides for subsequent movement of the plunger 19, and for example movement such as away or towards the base portion 14, in order to push against the presenter abutment surface 16 adjacent to the door 12a and thereby present the door 12a. In one configuration the plunger 19 is a linearly extending and retracting member, which when extended includes an end which is displaced away from the base portion 14. The presentment mechanism as illustrated in FIG. 3 is not associated with ratchet 124, the ratchet 124 not being configured to be extended beyond the perimeter of the base portion 14, nor being configured to be displaced away from the base portion 14 such as the plunger 19 being configured for so doing.

Optionally, aspects of presenter assembly 31 can be suitable for use with a lift gate handle assembly for a lift gate (e.g. closure panel 12a) or tailgate (e.g. closure panel 12a) of the vehicle 12, while remaining within the spirit and scope of the described embodiments.

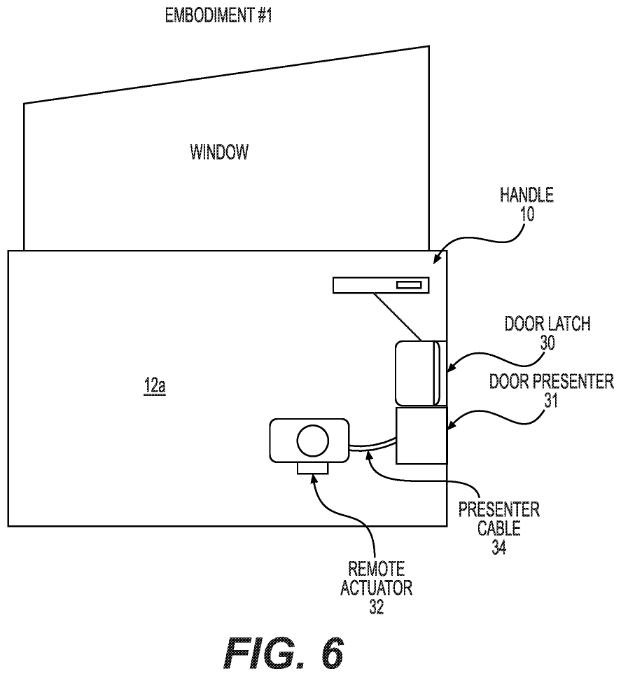

Referring to FIGS. 3 and 6, shown is a first embodiment of the presenter assembly 31 in relation to the latch assembly 30 and the remote actuator 32. The remote actuator 32 is mounted on the body 11, such as on the frame of the door 12a. As such, operation of the remote actuator 32 can be performed separately with respect to each of the independent systems of the latch assembly 30, the presenter assembly 31 and the handle 10. For example, the remote actuator 32 can be operated first (i.e. independently of the latch assembly 30) in order to automatically operate the plunger 19 from the home position to the presentment position, once the latch assembly 30 is placed in the unlatched or unlocked state. For example, once the handle 10 is gripped and moved by the user, latch assembly 30 is operated and then the remote actuator 32 is engaged (e.g. notified by an open signal sent to the remote actuator 32 by a Body control Module 52 (BCM 52), such that the presenter linkage 34 is operated by the remote actuator 32 in conjunction with the presentment lever 20. This can occur once the latch assembly 30 is operated in order to release the pawl 125 of the latch 30 (see FIG. 4) and thus release the ratchet 124, in order to allow the striker 7 to be removed from the ratchet 124 as the door 12a is presented to the user (e.g. automatically via the presenter mechanism 31a). One illustrative example of a latch release mechanism for moving pawl 125 is the powered release configuration as shown in commonly owned U.S. Pat. No. 8,474,888 entitled “Closure latch for vehicle door”, the entire contents of which are incorporated herein by reference. It is recognized that the FOB 70 and/or sensors 58 (e.g. proximity sensors, touch sensors, etc.—see FIGS. 9, 10) associated with the latch assembly 30 and remote actuator 32 can be used to send the presentment signal (e.g. via communication 59) to the BCM 52 (e.g. vehicle controller) and/or the remote actuator 32. It is recognized that the latch controller 56 can be configured directly in communication with the remote actuator 32, with the sensor 58 to control the remote actuator 32 in a manner as described herein, as illustrated in FIGS. 9 and 10.

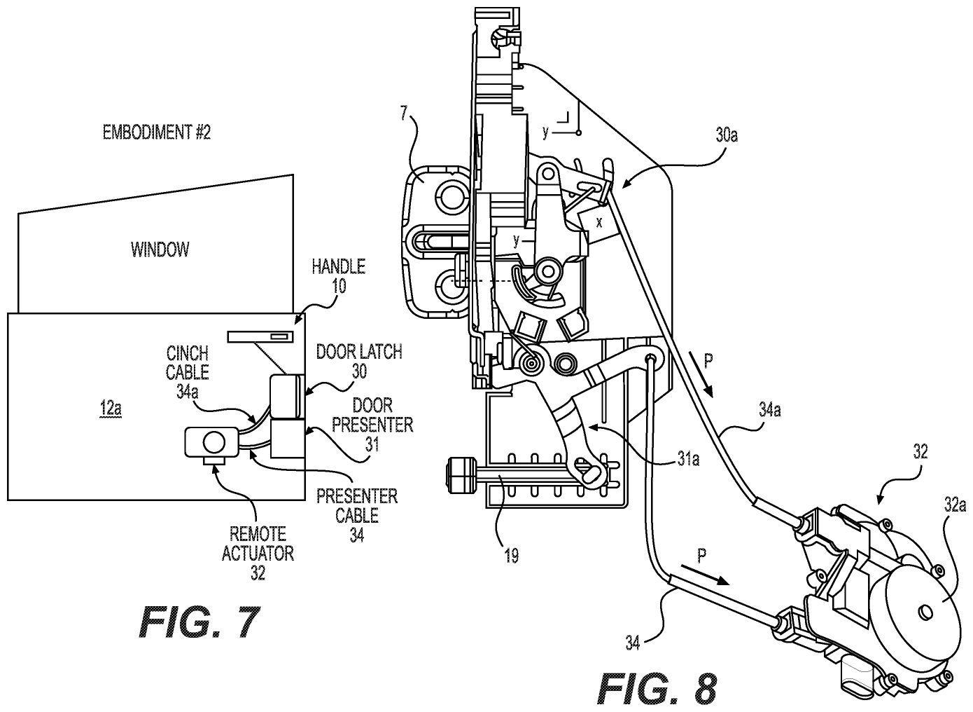

Referring to FIGS. 7 and 8, shown is an alternative embodiment of the remote actuator 32 using a pair of linkages 34, 34a in connection with operation of both the latch assembly 30 and the presenter assembly 31, such that the remote actuator 32 is shared between the presenter mechanism 31 and latch mechanism 30 operations. Pair of linkages 34, 34a may be pulled by the remote actuator 32 as represented by arrows P, but linkages 34, 34a, can also be pushed by the remote actuator 32, depending upon the physical construction of the linkages 34, 34a (e.g. rod verses cable).

Referring to FIGS. 4, 5, shown is an example configuration of the latch mechanism 30a having a frame 114 (e.g. housing) mounted on the door 12a. for example, the base portion 14 can be part of the housing 114, as desired. The latch mechanism 30a is oriented on the door 12a so as to be aligned to engage the mating latch component (e.g. striker 7). A latch linkage 34a (e.g. cinch linkage 34a) can coupled to a member 120 (e.g. cinch arm) and also to one or more latch components 123 (e.g. the ratchet 124 and/or the pawl 125 as further described below with respect to embodiment #2 shown in FIGS. 7, and 8). As such, the member 120 can be actuated (e.g. pulled) by the latch linkage 34a to operate the door 12a from a partially closed position to a fully closed position, (e.g. a cinched position), as the member 120 can be coupled to the ratchet 124 via a cinch lever arm 121. For example, the member 120 is connected to the cinch arm 121 by pivot 134 and the cinch arm 121 can be coupled to the ratchet 124 by pin 135. It is also recognized that the latch linkage 34a can be provided as a rigid linkage rather than as a flexible linkage involving cables. For example, the latch linkage 34a can be embodied as a sector gear (or other series of rigid members) connected to the member 120 and/or the cinch lever 121 at one end of the latch linkage 34a, referred to as a latch cinch mechanism 50. One illustrative example of a latch release mechanism is the cinch mechanism as shown in commonly owned US patent application No. 2017/0089105A1 entitled “Automotive latch with pulley for flexible cable routing”, the entire contents of which are incorporated herein by reference.

The latch mechanism 30a includes the number of latch elements 123 (e.g. ratchet 124, latch linkage 34a, cinch lever 121 and pawl 125) that are configured to cooperate with the striker 7 in order to retain the striker 7 within a slot 13 when the door 12a is in the closed position (e.g. locked), or otherwise to drive the striker 7 out of the slot 13 when the door 12a is moved towards the open position. The slot 13 is sized for receiving the striker 7 therein, in other words the slot 13 of the latch mechanism 30a cooperates with a slot 103 of the ratchet 124. The slot 103 has an open top end and a closed bottom end as shown. The latch elements 123 of the ratchet 124 and pawl 125 are pivotally secured to the frame 114 via respective shafts 128, 126. Note that in FIG. 5, the latch mechanism 30a with associated ratchet 124 is shown in the fully or primary closed position (e.g. a cinched position). Rotation 60 about shaft 126 causes the pawl 125 to release the ratchet 124, thus allowing the ratchet 124 to rotate 62 about the shaft 126 and thus release the striker 7 from both the slot 103 and the slot 103. Contrary to the opening sequence of the latch mechanism 30a, once the striker 7 is subsequently received in the slots 13,103 upon closing of the door 12a, actuation of the latch linkage 34a (by the remote actuator 32) causes movement of the member 120 and coupled cinch lever arm 121 in order to rotate the ratchet 124 about the shaft 128 counter to the rotation 62 (shown) and thus cinch the striker 7 within the slots 13,103.

Referring to FIGS. 9 and 9A, shown is a component diagram of the embodiment of FIGS. 6, 7 for an actuation system 8. In this example, the latch assembly 30 has the latch cinch mechanism 50 coupled to the remote actuator 32 via latch linkage 34a. The presenter assembly 31 is also coupled to the remote actuator 32 by presenter linkage 34. The remote actuator 32 could also be coupled to the BCM 52 via electronic signal connection 54, such that the remote actuator 32 could communicate with the BCM 52 in order to instruct the latch controller 56 of the latch assembly 30 to release the pawl 125 (see FIG. 5). In another example, the remote actuator 32 could also be coupled to the latch controller 56 via electronic signal connection 54. In this example configuration, the latch linkage 34a can be electronic signal connection, such that sensors 58 in communication 59 with the remote actuator 32 can instruct the remote actuator 32 electronically via the electronic signal connection (e.g. latch linkage 34a) that the handle 10 has been operated by the user and thus electronically signals (via the latch linkage 34a) that the latch mechanism 30a should be unlatched (e.g. an electronic open signal command should be communicated by the BCM 52 to the latch mechanism 30a). It is also recognized that the FOB 70 could be used by the user to electronically activate the latch mechanism 30a, via instructing the BCM 52, using a wireless communication 72 (e.g. using the latch linkage 34a configured as an electronic signal connection as utilized by the BCM 52 in response to receiving the wireless communication 72 generated by the FOB 70).

As such, FIG. 9 demonstrates an electronic operation of the latch assembly 30 (e.g. as an e-Latch), utilizing the remote actuator 32 to assist with cinching. It is recognized that the FOB 70 and/or the sensors 58 (e.g. proximity sensors, touch sensors, etc.) associated with the presenter assembly 31 can be used to send a presentment signal to the BCM 52 and/or the remote actuator 32, in order to instruct the remote actuator 32 to operate the plunger 19 from the home position to the presentment position, once the latch mechanism 30a is unlatched.

Similarly, upon closing of the door 12a, the sensors 58 in communication 59 with the remote actuator 32 can instruct the remote actuator 32 that the latch mechanism 30a is in the latched (e.g. secondary) position with the ratchet 124 engaged with the striker 7, and thus signals that the latch mechanism 30a should be cinched (e.g. an electronic cinch signal command could be communicated by the BCM 52 to the remote actuator 32, thus operating the latch linkage 34a and thus operating the cinch mechanism 50).

FIG. 9 illustrates an embodiment where the presenter mechanism 31a is not integrated with latch assembly 30, for example the presenter mechanism 31a does not share a common mounting and support structure such as base portion 14. FIG. 9A illustrates an embodiment where the presenter mechanism 31a is integrated with latch assembly 30, for example the presenter mechanism 31a shares a common mounting and support structure such as base portion 14 as illustrated in FIG. 2a.

Referring to FIG. 10, shown is a component diagram of the embodiment of FIGS. 3, 6 for the actuation system 8. In this example, the latch assembly 30 does not have the latch cinch mechanism 50 coupled to the remote actuator 32 via latch linkage 34a (shown in FIG. 9). The presenter assembly 31 is also coupled to the remote actuator 32 by the presenter linkage 34. The remote actuator 32 could also be coupled to the BCM 52 via electronic signal connection 54, such that the remote actuator 32 could communicate with the BCM 52 in order to instruct the latch controller 56 of the latch assembly 30 to release the pawl 125 (see FIG. 5).

In this example configuration, the latch linkage 34a can be electronic, such that sensors 58 in communication 59 with the remote actuator 32 can instruct the remote actuator 32 that the handle 10 has been operated by the user and thus signals that the latch mechanism 30a should be unlatched (e.g. an electronic open signal command should be communicated by the BCM 52). It is also recognized that the FOB 70 could be used by the user to electronically activate the latch mechanism 30a, via instructing the BCM 52, using a wireless communication 72 (as received by the BCM 52). It is recognized that the FOB 70 and/or the sensors 58 (e.g. proximity sensors, touch sensors, etc.) associated with the presenter assembly 31 can be used to send a presentment signal to the BCM 52 and/or the remote actuator 32, in order to instruct the remote actuator 32 to operate the plunger 19 from the home position to the presentment position, once the latch mechanism 30a is unlatched.

FIG. 10 illustrates an embodiment where the presenter mechanism 31a is not integrated with latch assembly 30, for example the presenter mechanism 31a does not share a common mounting and support structure such as base portion 14. FIG. 10A illustrates an embodiment where the presenter mechanism 31a is integrated with latch assembly 30, for example the presenter mechanism 31a shares a common mounting and support structure such as base portion 14 as illustrated in FIG. 2a. One illustrative example of a non-integrated presenter mechanism 31a is the door presenter mechanism as shown in commonly owned US patent application No. 2019/0153768 entitled “Power door presenter”, the entire contents of which are incorporated herein by reference.

Accordingly, the remote actuator 32 is considered remote from the base portion 14, as mounted on a portion of the door 12a spaced apart from the mounting of the base portion 14 (with co-mounted latch assembly 30 and presenter assembly 31) on a different portion of the door 12a. As such, the presenter linkage 34 is used to couple the remote actuator 32 function with the presenter mechanism 31a and optionally the cinching mechanism 50 of the latch mechanism 30a, i.e. bridge the spacing between the presenter mechanism 31a, optionally the latch mechanism 30a, and the housing 32a of the remote actuator 32.

In view of the above described embodiments, presented are embodiments including; 1) distancing the remote actuator 32 from the presenter assembly 31 in order to facilitate better packaging and reduce presenter assembly 31 positioning constraints; and 2) providing a single remote actuator 32 that is shared in order to manage both latch assembly 30 specific functions (e.g. cinching) and presentment deployment functions (e.g. movement of the plunger 19 from the home to the presentment position).

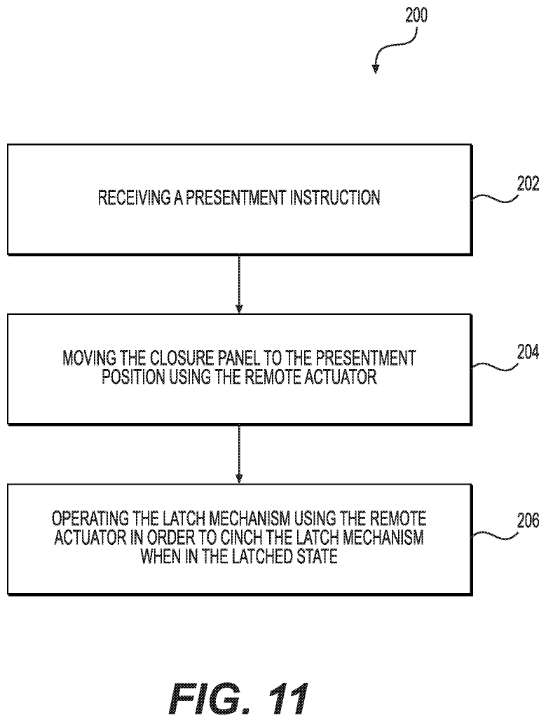

Referring to FIG. 11, shown is an actuation method 200 for operating a closure panel 12a of a vehicle 12, the method 200 comprising the steps of: receiving 202 a presentment instruction for operating the presenter mechanism 31a from the home position to the presentment position, the presenter mechanism 31a having the plunger 19 for moving the closure panel 12a from the home position to the presentment position, the presenter mechanism 31a integrated on the base portion 14 with the latch mechanism 30a for latching and unlatching the closure panel 12a with respect to the body 11 of the vehicle 12. A further step is operating 204 the remote actuator 32 positioned on the body 11 remote from the base portion 14 in order to manipulate the presenter linkage 34 operatively coupling the remote actuator 32 to the plunger 19, in order to move the plunger 19 from the home position to the presentment position. A further step is operating 206 the latch mechanism 30a, the latch mechanism 30a operatively coupled to the remote actuator 32 by the latch linkage 34a separate from the presenter linkage 34.

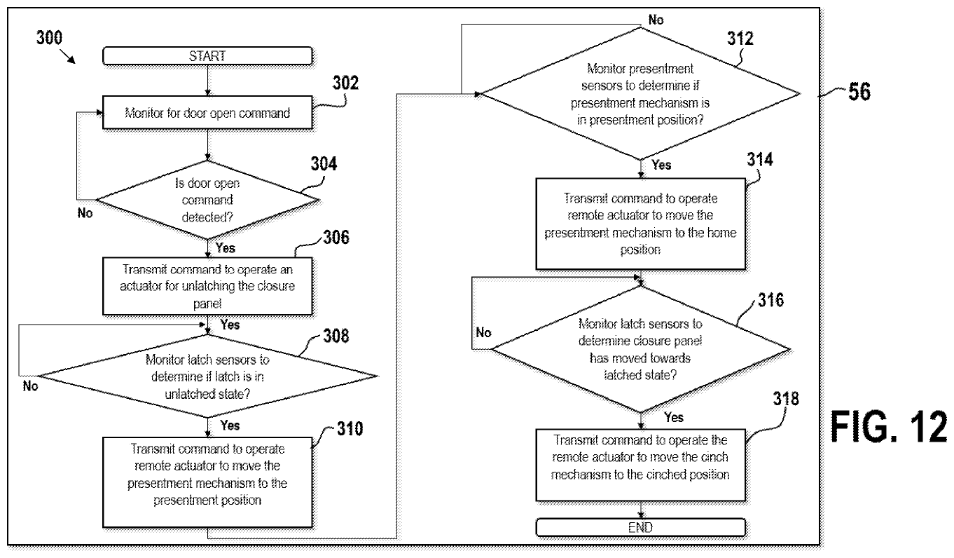

Now referring to FIG. 12, there is illustrated a method 300 of operating a remote actuator for controlling a presentment mechanism using a controller, such as latch controller 56 described herein above, in accordance with a possible configuration. The latch controller 56 may be configured for executing the steps of the method 300. Latch controller 56 may be provided as a microprocessor configured to execute software code and/or instructions stored for example on a memory unit (not shown), such as an EEPROM or other type or memory device such as a solid state disk, RAM, hard disk or the like storing the steps represented by the flow chart of FIG. 12. Latch controller 56 may also include dedicated signal processing hardware circuity for processing signals, sensor processing circuits, power control circuits, as well as may include software as executed by a microprocessor, and may include a combination of hardware and software components. Method 300 includes the steps of monitoring 302 for a door/closure panel open command, for example as received from FOB 70 or handle 10, and determining 304 if a door open command (e.g. an electrical signal) detected based on monitoring for a door open command. If so determined, then proceeding to transmitting 306 a command (e.g. an electrical signal) to operate an actuator (e.g. a local power release actuator) for unlatching the closure panel (e.g. for disengaging pawl 125 from ratchet 125), and then monitoring 308 latch sensors 101 coupled to the ratchet 124 and/or pawl 125 (e.g. hall sensors) to determine if the latch is in an unlatched state, and if so determined, proceeding to the step of transmitting 310 a command (e.g. an electrical signal) to operate remote actuator to move the presentment mechanism to the presentment position. Then, proceeding to the step of monitoring 312 the presentment sensors 99 to determine if the presentment mechanism is in presentment position, and if so determined, proceeding to the step of transmitting 314 a command (e.g. an electrical signal) to operate remote actuator to move the presentment mechanism to the home position. Then proceeding to the step of monitoring 316 the latch sensors 101 to determine the closure panel has moved towards latched state (e.g. having reached secondary position), and if so determined, proceeding to the step of transmitting 318 a command (e.g. electrical signal) to operate the remote actuator to move the cinch mechanism to the cinched position. It is recognized that these steps may be executed by other controllers, such as a Door Control Module or by the BCM as non-limiting examples.

1. An actuation system (8) for a closure panel (12a) of a vehicle (12), the actuation system having:
a base portion (14) for mounting to a body (11) of the vehicle, the base portion having mounted thereon on a latch mechanism (30a) for latching the closure panel between a locked and an unlocked state and a presenter mechanism (31a) for presenting the closure panel with respect to the body between a home position and a presentment position; and
a remote actuator (32) positioned on the body of the vehicle remote from the base portion, such that a presenter linkage (34) operatively couples operation of the remote actuator to the presenter mechanism, in order to move a presentment member (19) of the presenter mechanism to affect positioning of the closure panel between the home position and the presentment position.

2. The actuation system of claim 1, wherein the remote actuator is also remotely positioned from a housing (114) of the latch mechanism, the housing of the latch mechanism mounted on the body.

3. The actuation system of claim 2, wherein the base portion is part of the housing.

4. The actuation system of claim 1, wherein the body is of the closure panel.

5. The actuation system of claim 2, wherein the remote actuator is connected to the latch mechanism by a latch linkage (34a) for operating one or more latch elements (123) of the latch mechanism, the latch linkage separate from the presenter linkage.

6. The actuation system of claim 5 further comprising a cinch mechanism (50) incorporated in the latch mechanism as part of the one or more latch elements, such that the cinch mechanism is connected to the actuator by the latch linkage.

7. The actuation system of claim 1 further comprising a cinch mechanism (50) incorporated in the latch mechanism as part of one or more latch elements, such that the cinch mechanism is connected to the actuator by a latch linkage, the latch linkage separate from the presenter linkage.

8. The actuation system of claim 1 further comprising one or more sensors (99) associated with the presenter mechanism, the one or more sensors for indicating to at least one of a vehicle controller and the remote actuator that the latch mechanism is in the presentment position.

9. The actuation system of claim 1, wherein the presenter linkage is a cable.

10. The actuation system of claim 5, wherein the latch linkage is selected from the group consisting of a cable and a rod.

11. The actuation system of claim 7, wherein the latch linkage is selected from the group consisting of a cable and a rod.

12. The actuation system of claim 1, wherein the presenter mechanism is a plunger configured to be extended away from the base portion when in the presentment position.

13. The actuation system of claim 7, wherein the latch linkage is an electronic signal connection.

14. The actuation system of claim 1 further comprising a presentment lever (20) coupled to the base portion, such that the presentment lever has a first portion (22) connected to the presentment member and a second potion (23) connected to the presenter linkage.

15. The actuation system of claim 14, wherein the presentment lever is coupled to the base portion by a pivot (24)

16. The actuation system of claim 15 further comprising a resilient element (26) for biasing the presentment lever towards the home position.

17. The actuation system of claim 1, wherein the latch mechanism includes a ratchet for facilitating operation of the latch mechanism in a primary latched state, a secondary latched state and an open state.

18. The actuation system of claim 1, wherein the presenter mechanism is a plunger configured to be extended away from the base portion when in the presentment position.

19. An actuation method (200) for operating a closure panel of a vehicle, the method comprising the steps of:
receiving (202) a presentment instruction for operating a presenter mechanism from a home position to a presentment position, the presenter mechanism having a presentment member for moving the closure panel from the home position to the presentment position, the presenter mechanism integrated on a base portion with a latch mechanism for latching and unlatching the closure panel with respect to a body of the vehicle; and
operating (204) a remote actuator positioned on the body remote from the base portion in order to manipulate a presenter linkage operatively coupling the remote actuator to the presentment member, in order to move the presentment member from the home position to the presentment position.

20. The method of claim 19 further comprising the step of operating (206) the latch mechanism, the latch mechanism operatively coupled to the remote actuator by a latch linkage separate from the presenter linkage.

21. The method of claim 19, wherein said operating the latch mechanism performs a cinching operation of the latch mechanism.
